(19) United States
(12) Patent Application Publication
(10) Pub. No.: US 2025/0026564 A1
(43) Pub. Date: Jan. 23, 2025

(54) LIFTING ASSEMBLY

(71) Applicant: OCADO INNOVATION LIMITED, Hatfield, Hertfordshire (GB)

(72) Inventors: Wilhelm Karl JOHANNISSON, Hatfield, Hertfordshire (GB); Daniel CLARK, Hatfield, Hertfordshire (GB)

(73) Assignee: OCADO INNOVATION LIMITED, Hatfield, Hertfordshire (GB)

(21) Appl. No.: 18/707,991

(22) PCT Filed: Nov. 9, 2022
(86) PCT No.: PCT/EP2022/081364

§ 371 Date: May 7, 2024

(30) Foreign Application Priority Data
Nov. 11, 2021 (GB) 2116246.6
Dec. 23, 2021 (GB) 2118976.6
Jan. 25, 2022 (GB) 2200957.5

(51) Int. Cl. B65G 1/04; B66C 19/00; B66D 1/14; B66D 1/30; B66D 3/08

(52) U.S. Cl. CPC B65G 1/0464; B66C 19/00; B66D 1/14; B66D 1/30; B66D 3/08

(57) ABSTRACT

A container lifting assembly for raising and/or lowering containers stacked in stacks in a grid storage structure, includes a gripping device configured to releasably grip a container; a raising and lowering mechanism configured to raise and lower the gripping device; and a gearing mechanism configured to wind and/or unwind at least one tether. A motor is configured to actuate the gearing mechanism to wind and/or unwind the at least one tether. The at least one tether is connected to the gripping device such that winding and unwinding of the at least one tether is configured to raise and lower the gripping device.

### TECHNICAL FIELD

The present invention relates to the field of lifting assemblies. In particular, the present invention relates to lifting assemblies for load handling devices that lift and move storage containers.

### BACKGROUND

Some commercial and industrial activities require systems that enable the storage and retrieval of a large number of different products. WO2015/185628A describes a storage and fulfilment system in which stacks of storage containers are arranged within a grid storage structure. The containers are accessed from above by load handling devices operative on rails or tracks located on the top of the grid storage structure.

A given load handling device lifts a target container from the top of a stack, the target container usually containing inventory items needed to fulfil a customer order. The load handling device also lowers the target container back to the top of a stack, to the top of another stack or to another location, as required. The load handling devices typically comprise a lifting assembly for lifting the container from the first location and lowering the container to the second location. The load handling device must reliably lift and lower each container from the required locations.

It is against this background that the present invention has been devised.

### SUMMARY OF INVENTION

In a first aspect, there is provided a container lifting assembly for raising and/or lowering containers stacked in stacks in a grid storage structure, the lifting assembly comprising:
a gripping device configured to releasably grip a container;
a raising and lowering mechanism configured to raise and lower the gripping device the raising and lowering mechanism comprising:
a gearing mechanism configured to wind and/or unwind at least one tether;
a motor configured to actuate the gearing mechanism to wind and/or unwind the at least one tether;
wherein the at least one tether is connected to the gripping device such that winding and unwinding of the at least one tether is configured to raise and lower the gripping device.

The gearing mechanism may comprise a spool (e.g. at least one spool, for example a spool for each tether). The tether (e.g. the at least one tether) may extend from the spool before extending and connecting to the gripping device. The gearing mechanism may be configured to wind and/or unwind the tether about the spool. The raising and lowering mechanism may comprise a pair of tethers (e.g. at least a pair of tethers, for example two pairs of tethers) and a spool for each pair of tethers. The gearing mechanism may be configured to wind and/or unwind the pair of tethers about the spool. The raising and lowering mechanism may comprise at least one pulley (e.g. at least one pulley for each tether). The tether may extend from the spool to the pulley before extending and connecting to the gripping device. Where the raising and lowering mechanism comprises a spool for each pair of tether, each tether in the pair of tethers may extend from the spool in opposite directions to a pulley before extending and connecting to the gripping device. The raising and lowering mechanism may comprise a pulley for each tether.

The raising and lowering mechanism may comprise at least one tether (e.g. one, two, three, four etc. tethers). The or each tether may extend from the gearing mechanism to a corner of the gripping device.

The raising and lowering mechanism may comprise a horizontally extending lifting shaft. The raising and lowering mechanism may comprise two spools, e.g. a first spool may be at a first end of the lifting shaft and/or a second spool may be at a second end of the lifting shaft, the second end being opposite the first end. The raising and lowering mechanism may comprise two tethers at the first end of the lifting shaft configured to wind and/or unwind from the first spool. The raising and lowering mechanism may comprise two tethers at the second end of the lifting shaft configured to wind and/or unwind from the second spool.

The raising and lowering mechanism may comprise four spools, e.g. two spools at the first end of the lifting shaft and/or two spools at the second end of the lifting shaft. The raising and lowering mechanism may comprise two tethers at the first end of the lifting shaft, each tether being configured to wind and unwind from a respective spool at the first end of the lifting shaft (i.e. each tether at the first end of the lifting shaft extends from its own spool). The raising and lowering mechanism may comprise two tethers at the second end of the lifting shaft, each tether being configured to wind and unwind from a respective spool at the second end of the lifting shaft (i.e. each tether at the second end of the lifting shaft extends from its own spool).

At least one spool of the raising and lowering mechanism may comprise a slip clutch (i.e. the spool may be mounted to the lifting shaft via a slip clutch). Each spool of the raising and lowering mechanism may be mounted to the lifting shaft via a respective slip clutch. At least one pulley may comprise a hard stop (e.g. a mechanical stop) against which the gripping device abuts once it reaches its fully lifted position (i.e. when the gripping device is fully lifted by the raising and lowering mechanism). Each pulley of the raising and lowering mechanism may comprise a hard stop (e.g. a mechanical stop) such that as each tether is wound to raise the gripping device, each corner of the gripping device may abut against the hard stop once it reaches its fully lifted position. The motor may be configured to rotate the lifting shaft so as to wind or unwind the tethers thereby lifting or lowering the gripping device. During lifting and/or lowering of the gripping device, the gripping device may become uneven, i.e. one side of the gripping device may be higher than the other side, or one or more corners of the gripping device may be higher than the remaining corners of the gripping device. As the gripping device is lifted to its fully lifted position, the gripping device side that is higher or the corner(s) that are higher may reach their fully lifted positions and abut against the hard stops before the uneven lower side or corner(s) of the gripping device reach the hard stops.

To level an uneven gripping device, the motor may over rotate the lifting shaft so as to bring up the uneven lower side or lower corner(s) of the gripping device. During this over driving or over rotation of the motor, the slip clutch(es) at the side or corner(s) already at the fully lifted position can slip and prevent further rotation of those spools, thereby keeping the side or corner(s) already at the fully lifted position abutted against the hard stops. The motor may over elevate the gripping device against the hard stops each time the gripping device is raised. The slip clutch(es) may allow the motor to over rotate the lifting shaft and bring up any uneven lower side or corner(s) of the gripping device, while keeping any side or corner(s) of the gripping device already at the fully lifted position abutted against the hard stops. In this way, the lifting assembly can calibrate and level the gripping device each time the gripping device is raised.

The slip clutch may be centrally located on the spool and may include a shaft or hollow bore which is mounted to the lifting shaft, thereby mounting the spool to the lifting shaft. The slip clutch may be a spring clutch or an electromagnetic clutch (e.g. a permanent magnet clutch or a hysteresis/magnetic particle clutch). The slip clutch may be a fixed torque or an adjustable torque clutch.

The gearing mechanism may be provided on the gripping device. As the gearing mechanism winds the tether (e.g. the at least one tether), the gripping device may climb towards the top of the lifting assembly, i.e. as opposed to being pulled to the top of the lifting assembly (e.g. in embodiments where the gearing mechanism is not provided on the gripping device, for example above the gripping device and/or in the load handling device). The motor may be provided on the gripping device. As such, the gripping device may be self-powered, i.e. the gripping device may use power from the motor on the gripping device (i.e. and may not require power from the load handling device).

The gearing mechanism may comprise a planetary gear set or a worm gear or any other gearing mechanism suitable for winding and/or unwinding tethers.

The tether(s) may be in the form of cables, ropes, tapes or any other form of tether with the necessary physical properties to lift the containers. The tethers may be formed of or comprise polyester material (e.g. woven polyester material). In particular, the tethers may comprise woven polyester tapes or belts, e.g. seat belts (i.e. seat belts may be used as the tethers). The tethers may comprise dyneema tape. The tethers may comprise polyester material (e.g. woven polyester) combined with dyneema tape. The tethers may comprise cotton material. The tethers may comprise webbing material, e.g. webbed polyester, nylon, cotton. The tethers may comprise conductive material, for example the tethers may comprise woven material or woven polyester material with a conductive element or wiring (e.g. copper) woven into the weave or fabric of the tethers. The tethers may comprise woven belts (e.g. seat belts) with a conductive element or wiring woven into the belt. The tethers may comprise a conductive element or wiring (e.g. copper) woven into the weave or fabric of the tethers so as to provide power and/or communication (i.e. electrical communication) to the gripping device. In another aspect, there is provided a container lifting assembly according to the first aspect, wherein the raising and lowering mechanism comprises:
a horizontally extending lifting shaft, a first spool, a second spool, a third spool, and a fourth spool, wherein the first and second spools are located at or near a first end of horizontally extending lifting shaft, and the third and fourth spools are located at or near a second end opposite the first end of the horizontally extending lifting shaft; and
a first tether, a second tether, a third tether, and a fourth tether configured to wind and unwind from the first, second, third, and fourth spools respectively, wherein the first and second spools are configured to rotate in an opposite direction to the third and fourth spools to wind and unwind the first, second, third, and fourth tethers.

The first and second spools may be on a first shaft, the third and fourth spools may be on a second shaft, wherein the gearing mechanism may comprise first and second pulleys on the first and second shafts respectively, the first and second pulleys driven via a timing belt in opposite directions.

The gearing mechanism further may further comprise third and fourth pulleys arranged about either the first or second pulley to effect opposite rotation of the first and second pulleys via the timing belt.

Any one of the first, second, third, and fourth pulleys may be driven directly by the motor.

The gearing mechanism may comprise first and second worm gears on a shaft driven by the motor, wherein the worm gears are configured to effect rotation of the first and second spools in the opposite direction to the third and fourth spools.

The first and second spools may be on a first shaft, the third and fourth spools may be on a second shaft, wherein the gearing mechanism may further comprise first and second gears on the first and second shafts respectively, the first and second gears driven via the first and second worm gears respectively.

In another aspect, there is provided a container lifting assembly according to the first aspect, wherein the raising and lowering mechanism comprises:
a horizontally extending lifting shaft, a first spool, a second spool, a third spool, and a fourth spool, wherein the first and second spools are located at or near a first side of and adjacent to a centre axis of the horizontally extending lifting shaft, and the third and fourth spools are located at or near a second side of and adjacent to the centre axis, wherein the first side is opposite the second side; and
a first tether, a second tether, a third tether, and a fourth tether configured to wind and unwind from the first, second, third, and fourth spools respectively, wherein the first and second spools are configured to rotate in an opposite direction to the third and fourth spools to wind and unwind the first, second, third, and fourth tethers.

The first and second spools may be on a first shaft, the third and fourth spools may be on a second shaft, the first and second shafts parallel to the central axis.

The gearing mechanism may comprise first and second gears on the first and second shafts respectively, wherein the first and second gears mesh such that the motor driving either the first or second shaft rotates the other of the first or second shafts.

Each tether may be coupled to a respective pulley located at or near a respective corner of the lifting assembly.

In any of the above aspects, the first, second, third, and fourth tethers are configured such that a point at which each tether winds and unwinds to or from a respective spool or pulley is at or near a respective corner of the lifting mechanism.

Each tether may connect to the gripping device at or near a respective corner of the gripping device.

In any of the above aspects, the at least one spool comprises at least one groove along its circumference into which a wire tether is configured to wind.

In another aspect, there is provided a load handling device for lifting and moving containers stacked in stacks in a grid storage structure comprising a plurality of tracks arranged in a grid pattern above the stacks of containers, the load handling device comprising:

a body housing a driving mechanism operatively arranged for moving the load handling device on the grid;

a container lifting assembly as described above, configured to raise and lower the gripping device relative to the body and for raising and lowering containers stacked in stacks.

The lifting assembly may be located within the body of the load handling device. The lifting assembly may raise a container into the body (e.g. into a cavity of the load handling device).

The tethers may comprise a conductive element or wiring (e.g. copper) woven into the weave or fabric of the tethers so as to provide power and/or communication (i.e. electrical communication) between the load handling device (e.g. a power source or a communication source provided in the body of the load handling device) and the gripping device.

In another aspect, there is provided a load handling device for lifting and moving containers stacked in stacks in a grid storage structure comprising:
a first set of parallel tracks and a second set of parallel tracks extending substantially perpendicularly to the first set of tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces; the load handling device comprising:
a body mounted on a first set of wheels being arranged to engage with the first set of parallel racks and a second set of wheels being arranged to engage with the second set of parallel tracks, the body housing a drive mechanism configured to drive the load handling device on the grid;
a container lifting assembly as described above, configured to raise and lower the gripping device relative to the body and for raising and lowering containers stacked in stacks.

In another aspect, there is provided a method of raising and/or lowering a container from a stack of containers, the method comprising the load handling device as described above, the method comprising the steps of:
actuating the gearing mechanism so as to unwind the at least one tether and lower the gripping device relative to the body
actuating the gripping device to grip a container
actuating the gearing mechanism so as to wind the tethers and raise the gripping device relative to the body.

The method may comprise the step of raising the gripping device relative to the body and lifting the container into a cavity of the load handling device.

In another aspect, there is provided a system comprising:
a load-handling device as defined above;
a storage structure for accommodating containers stacked in stacks, the storage structure including a first set of tracks extending in a first direction and a second set of tracks extending in a second direction transverse to the first direction, the load-handling device configured to move on the first and second sets of tracks,
a control utility configured to control the load handling device to lift a container from a stack beneath the grid and/or lower a container into the grid.

### BRIEF DESCRIPTION OF THE DRAWINGS

Aspects and example embodiments of the present invention will now be described with reference to the accompanying drawings.

FIG. 1 is a schematic perspective view of a grid storage structure and containers;

FIG. 2 is a schematic top view of a track on top of the storage structure of FIG. 1;

FIG. 3 shows load handling devices on top of the storage structure of FIG. 1;

FIG. 4 is a schematic perspective view of a load handling device with a lifting assembly in a lowered configuration;

FIG. 5 shows schematic cutaway views of the load handling device of FIG. 4 with the lifting assembly in a raised and a lowered configuration;

FIGS. 6A, 6B and 6C are perspective views of the load handling device with an embodiment of lifting assembly being lowered onto a container;

FIG. 7 is a front view of an embodiment of lifting assembly;

FIGS. 8 and 9 are top views of the lifting assembly of FIG. 7;

FIG. 10 is a perspective view of another embodiment of lifting assembly;

FIGS. 11A, 11B and 11C are perspective, side and front views of one of the spools in the lifting assembly of FIG. 10;

FIG. 12 is a perspective view of another embodiment of lifting assembly;

FIG. 13 is a perspective view of a raising and lowering mechanism of another embodiment of lifting assembly;

FIGS. 14A and 14B are a perspective views of another embodiment of lifting assembly;

FIG. 15 is a perspective view of another embodiment of lifting assembly; and

FIG. 16 is a perspective view of another embodiment of lifting assembly;

FIG. 17 is a perspective view of another embodiment of lifting assembly;

FIG. 18 is a perspective view of another embodiment of lifting assembly; and

FIG. 19 is a perspective view of another embodiment of lifting assembly.

### DETAILED DESCRIPTION

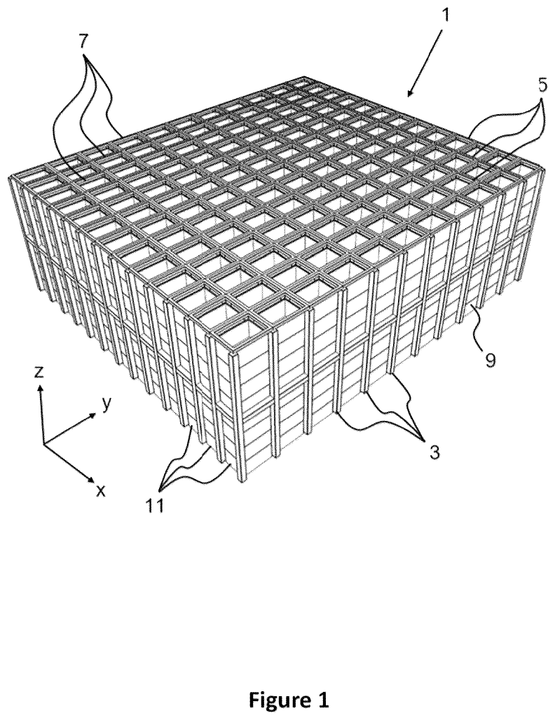

FIG. 1 illustrates a storage structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, storage containers 9 are arranged in stacks 11 beneath the grid cells defined by the grid pattern, one stack 11 of containers 9 per grid cell.

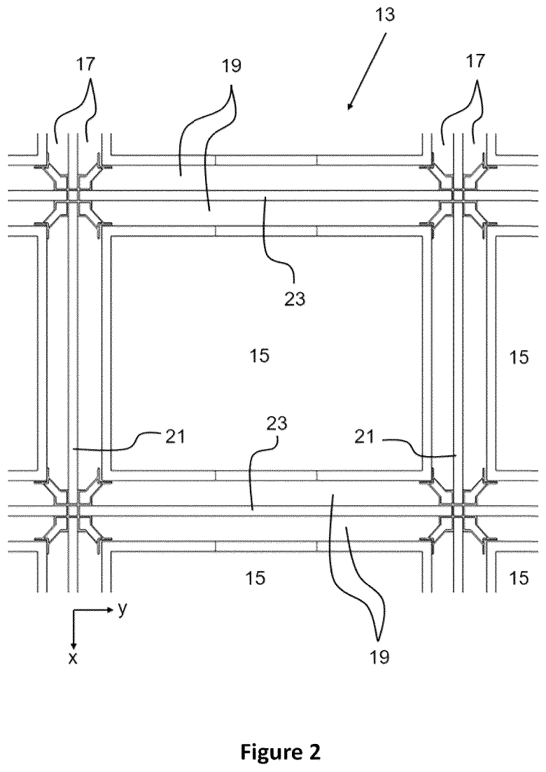

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

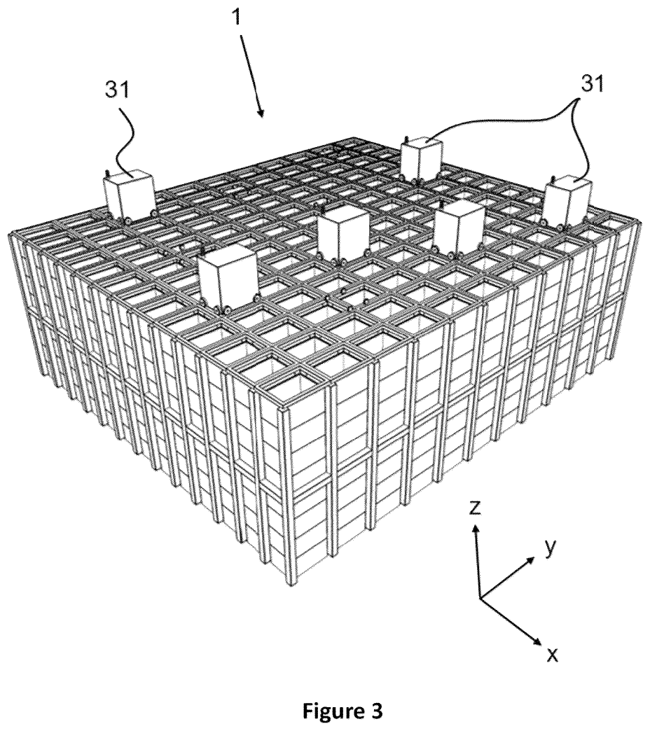

FIG. 3 shows a plurality of load handling devices 31 moving on top of the storage structure 1 illustrated in FIG. 1. The load handling devices 31, which may also be referred to as robots or bots, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

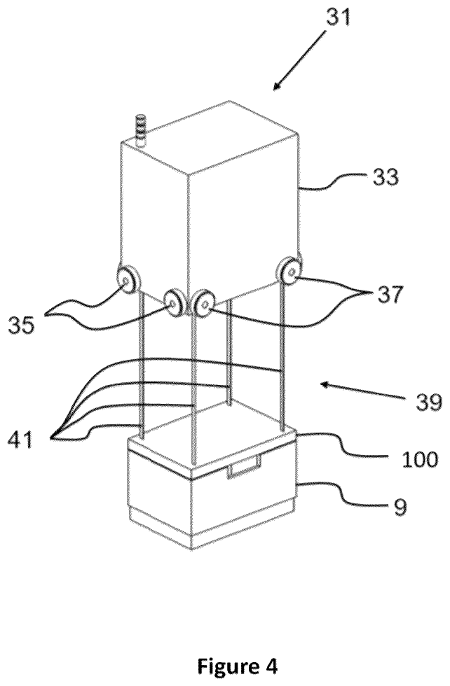

As illustrated in FIG. 4, the bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (not visible in FIG. 4). The wheels 35 engage with the tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (not visible in FIG. 4). The wheels 37 engage with the tracks 19 and are rotatably mounted on the body 33 of the bot 31 to allow the bot 31 to move along the tracks 19.

The bot 31 also comprises a lifting assembly 102 comprising a raising and lowering mechanism 39 configured to raise and lower containers 9. The illustrated raising and lowering mechanism 39 comprises four tethers 41 which are connected at their lower ends to a gripping device 100. The tethers 41 may be in the form of cables, ropes, tapes, or any other form of tether with the necessary physical properties to lift the containers 9. The gripping device 100 comprises at least one gripper configured to engage with features of the containers 9. For example, the containers 9 may be provided with one or more apertures in their upper sides with which the gripper can engage. Alternatively or additionally, the gripper may be configured to hook under the rims or lips of the containers 9, and/or to clamp or grasp the containers 9. The tethers 41 may be wound up or down to raise or lower the gripping device 100, as required. One or more motors or other means may be provided to effect or control the winding up or down of the tethers 41.

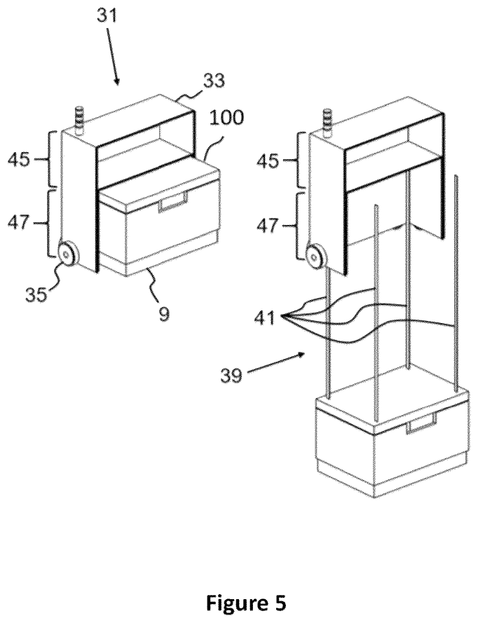

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lifting assembly 102 is in an upper part of the lower portion. However, in other embodiments, it may be in the upper portion 45. The lower portion 47 comprises a container-receiving space or cavity for accommodating at least part of a container 9 that has been raised by a lifting assembly 102 that comprises the raising and lowering mechanism 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the lifting assembly 102 controls the tethers 41 to lower the gripping device 100 and the corresponding container 9 out of the cavity and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

The container-receiving space of the bot 31 may not be within the body 33 of the bot 31. For example, the container-receiving space may instead be adjacent to the body 33 of the bot 31, e.g. in a cantilever arrangement with the weight of the body 33 of the bot 31 counterbalancing the weight of the container to be lifted. In such embodiments, a frame or arms of the raising and lowering mechanism 39 may protrude horizontally from the body 33 of the bot 31, and the tethers 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

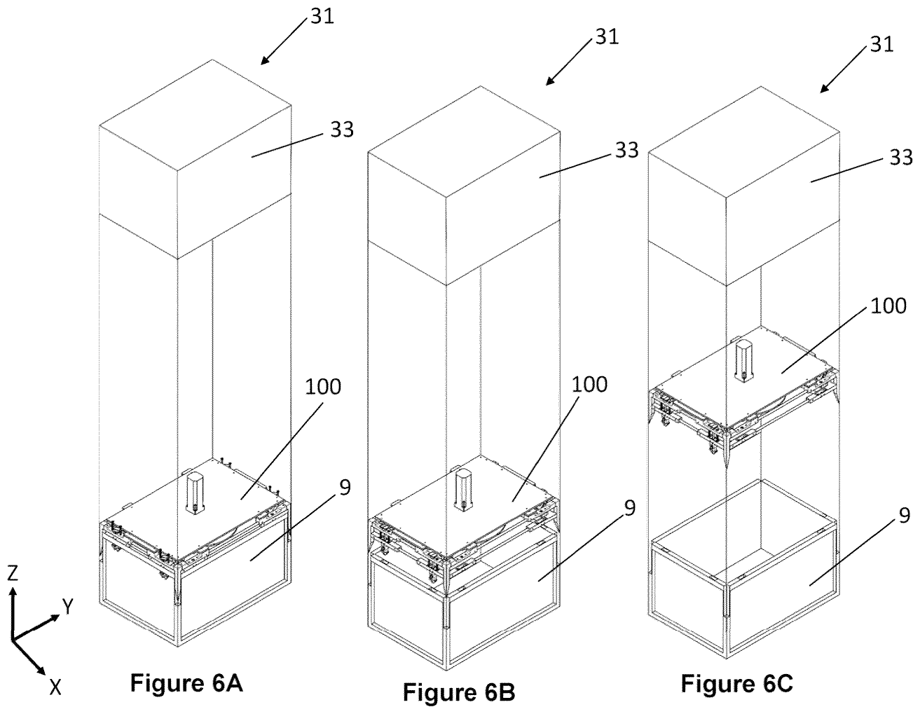

FIGS. 6A, 6B and 6C show perspective views of the load handling device 31 with an embodiment of gripping device 100 suspended from the load handling device 31, in particular from the load handling device body 33. Although not shown in these figures, the load handling device 31 includes the features described above in relation to the load handling device or bot 31, including the first and second sets of wheels 35, 37 mounted to the body of the load handling device 31, the cavity for receiving at least part of the container and the reeled tethers 41 connected at their lower ends to the gripping device 100 for connecting and suspending the gripping device 100 from the load handling device 31. The load handling device 31 comprises the lifting assembly 102 which winds or unwinds the reeled tethers 41, the tethers being wound and unwound respectively to raise and lower the gripping device 100 as shown in FIGS. 6A, 6B and 6C. The gripping device 100 is lowered onto a container to be lifted, until it contacts with an upper rim of the container 9. Once the gripping device 100 is into position on the container 9 as shown in FIG. 6C, the gripping device 100 engages and grips the container.

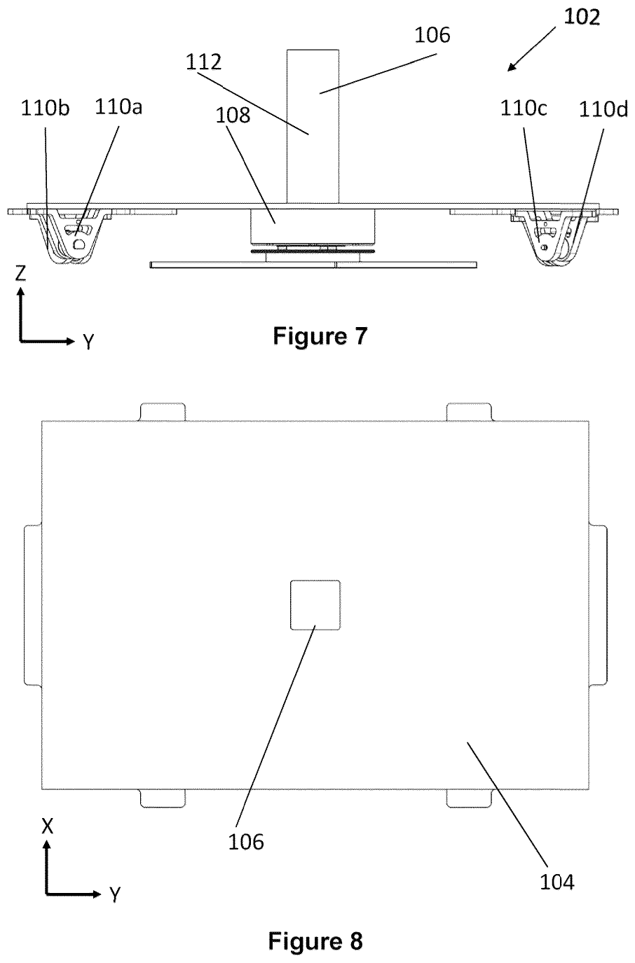

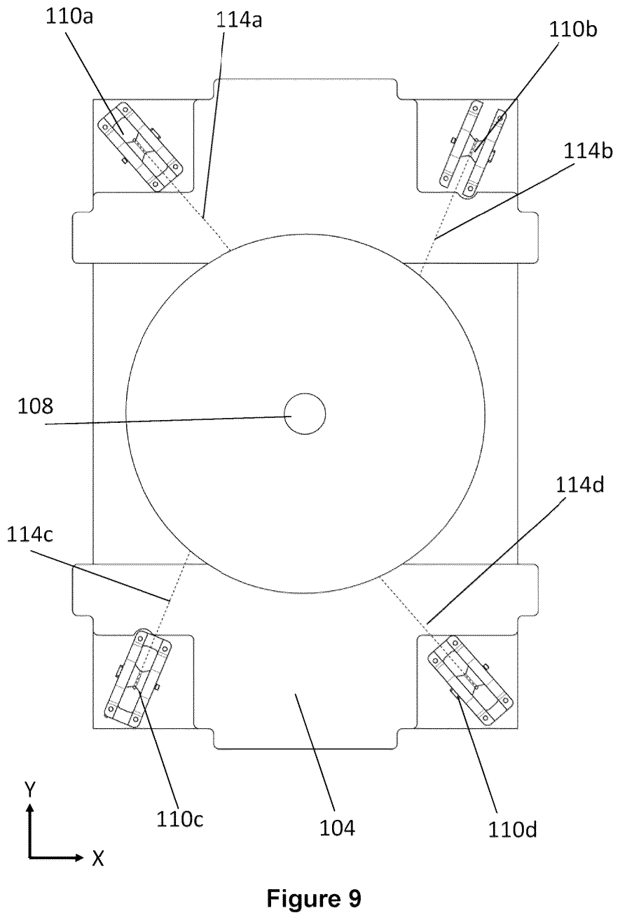

FIGS. 7 and 8 show an embodiment of the lifting assembly 102, FIG. 7 showing a front view of the lifting assembly 102 and FIG. 8 showing a top view of the lifting assembly 102. In this embodiment, the lifting assembly 102 includes a raising and lowering mechanism 39 comprising a rectangular support plate 104, a centrally located motor 106, a gearing mechanism 108 and four pulleys 110a, 110b, 110c, 110d fastened or connected to an underside of the support plate 104. In this embodiment, the gearing mechanism 108 is a planetary gear set (e.g. an epicyclic gear set) with a vertically extending lifting shaft 112 which rotates to wind or unwind the tethers. Each pulley 110a, 110b, 110c, 110d is located at or towards a corner of the lifting assembly 102, in particular at each corner of the support plate 104, and the tethers extend from the planetary gear set to the four pulleys 110a, 110b, 110c, 110d, before extending downwards such that a lower end of each pulley 110a, 110b, 110c, 110d connects to the gripping device 100. The motor 106 is configured to rotate the lifting shaft 112 so as to wind or unwind the tethers about the lifting shaft thereby lifting or lowering the gripping device 110. By winding or unwinding the tethers about the lifting shaft 112, the lifting shaft 112 in effect provides a spool for the tethers. As the motor 106 rotates the lifting shaft 112 in a first direction, the tethers are simultaneously wound about the lifting shaft 112 so as to lift the gripping device 100. The motor 106 rotates the lifting shaft in a second direction (opposite to the first direction) to simultaneously unwind the tethers from the lifting shaft 112 and lower the gripping device 100. The motor 106 rotates the lifting shaft 112 such that the tethers are wound and unwound at the same rate. In this embodiment, the motor 106 is located above the support plate 104. By centrally locating the motor 106 on the support plate 104 (as shown in FIG. 8), the weight of the motor 106 is evenly distributed across the lifting assembly 102. Furthermore, by providing the motor 106 on the support plate 104, the added weight of the motor 106 on the lifting assembly 102 can advantageously ensure a more stable lifting and lowering of the gripping device 100.

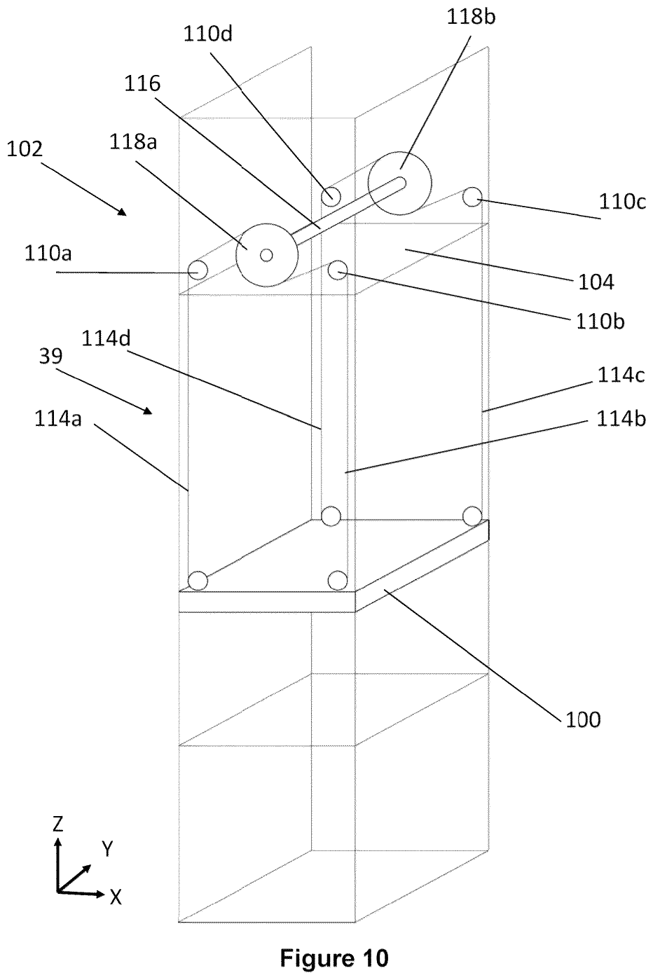

FIG. 9 shows a top view of the lifting assembly 102 of FIGS. 7 and 8 and shows the tethers 114a, 114b, 114c, 114d extending from the planetary gear set 108 to the four pulleys 110a, 110b, 110c, 110d. As shown in FIG. 9, each pulley 110a, 110b, 110c, 110d is angled towards the planetary gear set (i.e. towards the center of the lifting assembly 102 or the center of the support plate 104). By angling the pulleys 110a, 110b, 110c, 110d towards the center, the tethers 114a, 114b, 114c, 114d extend in a straight line from the center of the lifting assembly 102 (or from the gearing mechanism 108) to the pulleys. This allows the lifting assembly 102 to wind and unwind the tethers 114a, 114b, 114c, 114d (and thus lift and lower the gripping device 100) more evenly and more steadily without the risk of the tethers 114a, 114b, 114c, 114d getting stuck or tangled with each other as they are wound or unwound by the gearing mechanism 108.

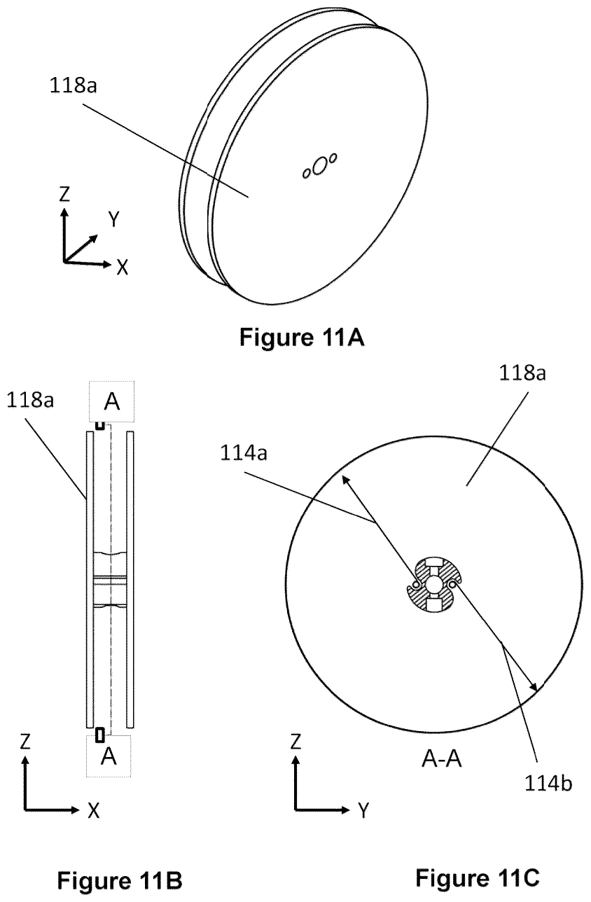

FIG. 10 shows another embodiment of lifting assembly 102. In this embodiment, the raising and lowering mechanism 39 includes a central horizontally extending lifting shaft 116 and two spools, a first spool 118a at a first end of the lifting shaft and a second spool 118b at a second end of the lifting shaft 116. Four pulleys 110a, 110b, 110c, 110d are provided at each corner of the lifting assembly 102, in particular at each corner of the support plate 104 and, in this embodiment, are located above the support plate 104. At each end of the lifting shaft 116, two tethers extend from each spool in opposite directions and through a respective pulley 110a, 110b, 110c, 110d before extending downwards such that the lower end of each tether 114a, 114b, 114c, 114d connects to the gripping device 100. As shown by FIG. 10, by providing the pulleys 110a, 110b, 110c, 110d at or towards each corner of the support plate 104, the tethers 114a, 114b, 114c, 114d can extend downwards such that the lower ends of each tether 114a, 114b, 114c, 114d connect to a corner of the gripping device 100, thereby providing a more stable lifting and lowering of the gripping device 100.

The lifting shaft 116 is configured to rotate so as to wind or unwind the tethers 114a, 114b, 114c, 114d about each spool 118a, 118b. As the lifting shaft 116 is rotated in a first direction, the two tethers 114a, 114b at the first end of the lifting shaft are wound about the first spool 118a, and simultaneously, the two tethers 114c, 114d at the second end of the lifting shaft are wound about the second spool 118b, thereby lifting the gripping device 100 (and a container when gripped by the gripping device). The lifting shaft 116 is rotated in a second direction (opposite the first direction), to simultaneously unwind the two tethers 114a, 114b from the first spool 118a and the two tethers 114c, 114d from the second spool 118b, thereby lowering the gripping device 100 (and a container when gripped by the gripping device). By providing two spools 118a, 118b, one on each end of the lifting shaft 116, each spool winds or unwinds two tethers, thereby reducing the risk of tangling of the tethers. Each spool 118a, 118b may include grooves to keep the two tethers being wound on the spool separate, thereby further reducing the risk of tangling of the tethers.

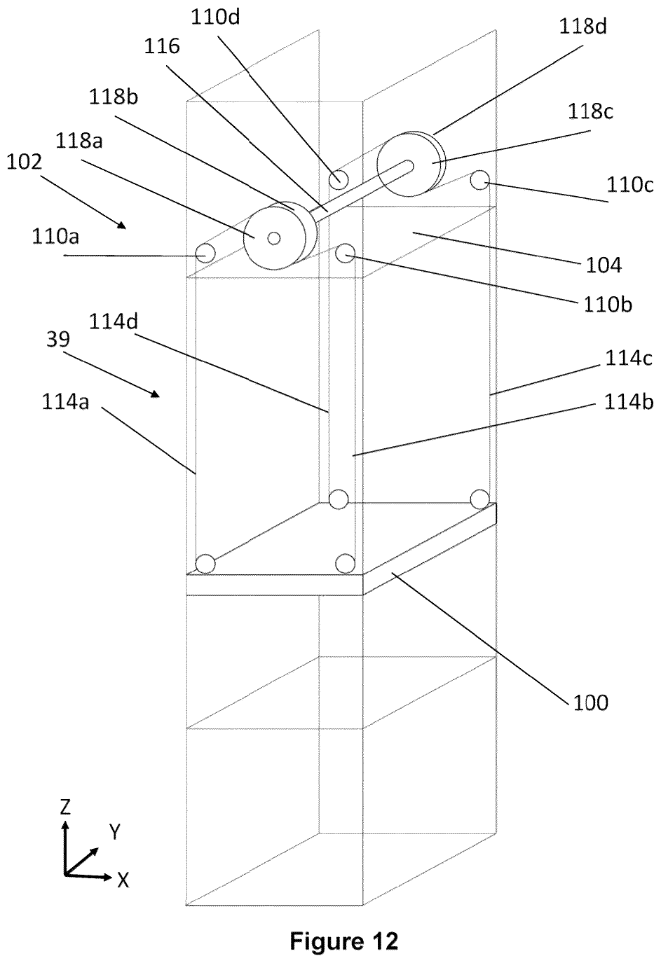

FIGS. 11A-C show views of one of the spools 118a, 118b from the embodiment of FIG. 10. FIG. 11C shows a section view through the section A-A in FIG. 11B. The arrows shown in FIG. 11C illustrate the direction of the two tethers 114a, 114b, 114c, 114d that extend from each spool 118a, 118b. As shown by FIG. 11C, the tethers 114a, 114b, 114c, 114d extend in opposite directions such that each tether 114a, 114b, 114c, 114d can be simultaneously unwound from the spool or wound from the spool.

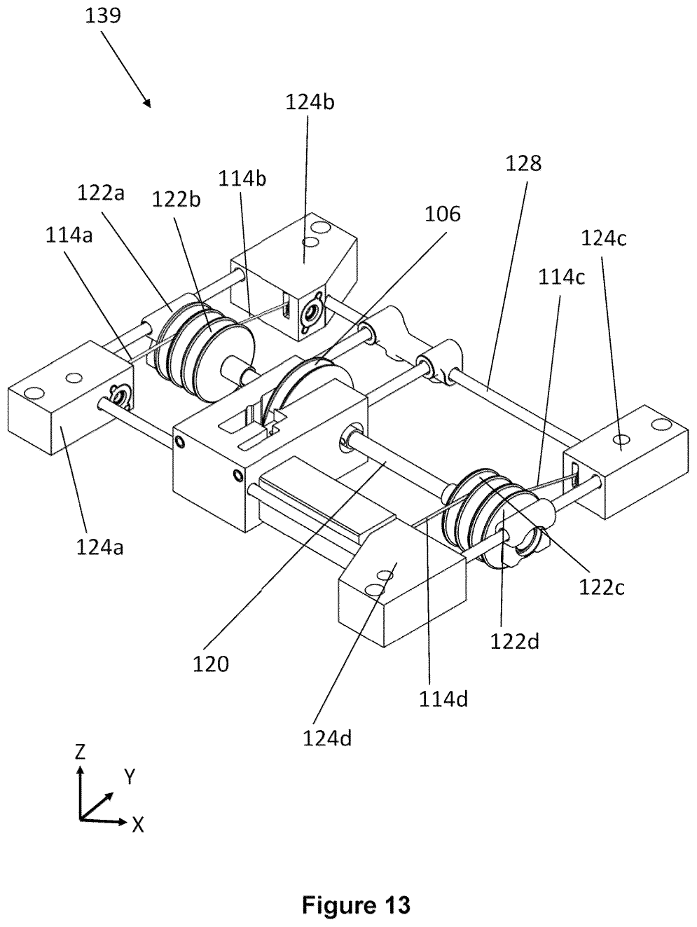

FIG. 12 shows another embodiment of lifting assembly 102. In this embodiment, the raising and lowering mechanism includes a central horizontally extending lifting shaft and four spools 118a, 118b, 118c, 118d, two spools at each end of the lifting shaft, i.e. two spools 118a, 118b at the first end of the lifting shaft 116 and two spools 118c, 118d at the second end of the lifting shaft 116. As with the embodiment of FIG. 10, four pulleys 110a, 110b, 110c, 110d are provided at each corner of the support plate 104. In this embodiment, each tether 114a, 114b, 114c, 114d extends from its own respective spool 118a, 118b, 118c, 118d and through a respective pulley 110a, 110b, 110c, 110d before extending downwards where the lower end of each tether connects to a corner of the gripping device. Each of the four tethers is connected to its own spool and extends through its own pulley before connecting to the gripping device 100. By providing four spools (i.e. one for each tether) each spool has a single tether that is wound or unwound on it, thereby further reducing the risk of tangling of the tethers. Furthermore, by providing a spool for each tether, the wound tether, when fully wound onto the spool (i.e. when the tether is completely wound onto the spool) occupies less space compared to embodiments where two or more tethers are wound onto a single spool. For example, by providing a spool for each tether, the wound tether will occupy half the amount of space compared to embodiments where two tethers are wound onto a single spool. This advantageously results in the lifting assembly 102 requiring less space in the load handling device 31 body 33, for example, the lower portion 47 of the load handling device 31 comprising the container-receiving space for accommodating the lifting assembly 102 and at least part of the container. In other words, by providing a spool for each tether, the lifting assembly 102 advantageously allows for space gain in the container-receiving space.

As the lifting shaft is rotated in a first direction to wind the tethers, each tether is simultaneously wound about its respective spool so as to lift the gripping device (and a container when gripped by the gripping device). The lifting shaft is rotated in a second direction (opposite the first direction), to simultaneously unwind each tether from its respective spool, thereby lowering the gripping device (and a container when gripped by the gripping device).

In the embodiments of FIGS. 10 and 12, the tethers connect to the gripping device 100 via four further pulleys (one at each corner of the gripping device). However, in other embodiments, the lower end of each tether may connect to the gripping device without the need for further pulleys (e.g. the lower end of the tethers may connect directly to the gripping device 100).

Although not shown in the embodiments of FIGS. 10 and 12, a motor 106 is provided to rotate the lifting shaft in the first and second directions. In each of the embodiments of FIGS. 7-12, the motor 106 is configured to rotate the lifting shaft such that all the tethers are wound or unwound simultaneously and at the same rate so as to lift and lower the gripping device evenly and steadily.

In some embodiments, each spool is mounted to the lifting shaft via a respective slip clutch. As the lifting shaft is rotated by the motor in the first direction, the tethers are wound to lift the gripping device. Once the gripping device 100 reaches its top or fully lifted position (i.e. the gripping device 100 is fully lifted by the raising and lowering mechanism 39 e.g. into the body 33 of the bot 31), the motor can over drive beyond the torque of the slip clutches such that the slip clutches slip and the spools no longer rotate. Each pulley comprises a hard stop (e.g. a mechanical stop) against which the gripping device abuts once it reaches its fully lifted position.

By providing a slip clutch for each spool, the lifting assembly 102 can level the gripping device 100 should the gripping device 100 become uneven (e.g. during lowering and/or lifting of the gripping device or due to stretching or slipping of one or more of the tethers). For example, in the embodiment of FIG. 10, the gripping device may become uneven during lowering and/or lifting of the gripping device such that a first end of the gripping device (i.e. the end lifted by the first spool at the first end of the lifting shaft) reaches its fully lifted position and abuts against the hard stops at the pulleys, while a second end of the gripping device (i.e. the end lifted by the second spool at the second end of the lifting shaft) has not yet reached its fully lifted position. The motor continues to rotate (i.e. over rotates) the lifting shaft such that the second end of the gripping device is lifted to its fully lifted position and abuts against the hard stop at the pulley. During this over rotation of the motor to rotate the lifting shaft and lift the second end of the gripping device, the slip clutch at the first spool slips and prevents further rotation of the first spool, thereby keeping the first end of the lifting shaft at its fully lifted position.

In the embodiment of FIG. 10, a slip clutch is provided at each spool, thereby allowing the lifting assembly 102 to level any unevenness between the first end and the second end of the gripping device.

In some embodiments of FIG. 12, a slip clutch is provided at each spool and each pulley comprises a hard stop (e.g. a mechanical stop) against which the gripping device abuts once it reaches its fully lifted position. As described above, by providing a slip clutch at each spool, the lifting assembly 102 is able to level the gripping device should it become uneven during lowering and/or lifting. If a side or a corner of the gripping device becomes uneven, the motor continues to rotate the lifting shaft until the uneven side or corner is lifted to its fully lifted position and abuts against the hard stop at the pulley. In the embodiment of FIG. 12 a spool is provided for each tether. As such a slip clutch can be provided at each spool to control the level of each individual tether. This advantageously allows the lifting assembly 102 to control and level each corner of the gripping device should it become uneven.

The motor over elevates against the hard stops each time the gripping device is lifted. This allows any side or corner of the gripping device that is uneven to be lifted to the hard stop. The slip clutches at each spool allow the motor to over rotate to lift any side or corner of the gripping device that is uneven, while keeping any side or corner of the gripping device already at the fully lifted position abutted against the hard stops. This advantageously allows the lifting assembly to calibrate and level the gripping device each time the gripping device is raised.

In embodiments including slip clutches, the slip clutch is centrally located on the spool (see FIG. 11C) and includes a shaft or a hollow bore which is mounted to the lifting shaft, thereby mounting the spool to the lifting shaft. The slip clutch is preferably an electromagnetic clutch (e.g. a hysteresis/magnetic particle clutch). These clutches operate via electric actuation, in particular where actuation of the clutch does not require touching of the internal elements of the clutch, thereby reducing wear of the clutch over time. By providing an electromagnetic clutch, these advantageously provide a reliable and durable method for levelling the gripping device. The slip clutch is a fixed torque clutch which slips at a predetermined torque.

In the embodiments of FIGS. 7-10 and 12, the lifting assembly 102 includes a support plate 104 for supporting the spools. The support plate 104 can also be provided to support the motor 106 as shown in the embodiment of FIGS. 7-9. However, in other embodiments, the support plate 104 may not be necessary. The spools and/or the motor 106 may be supported by alternative support means, including, for example one or more vertical shafts.

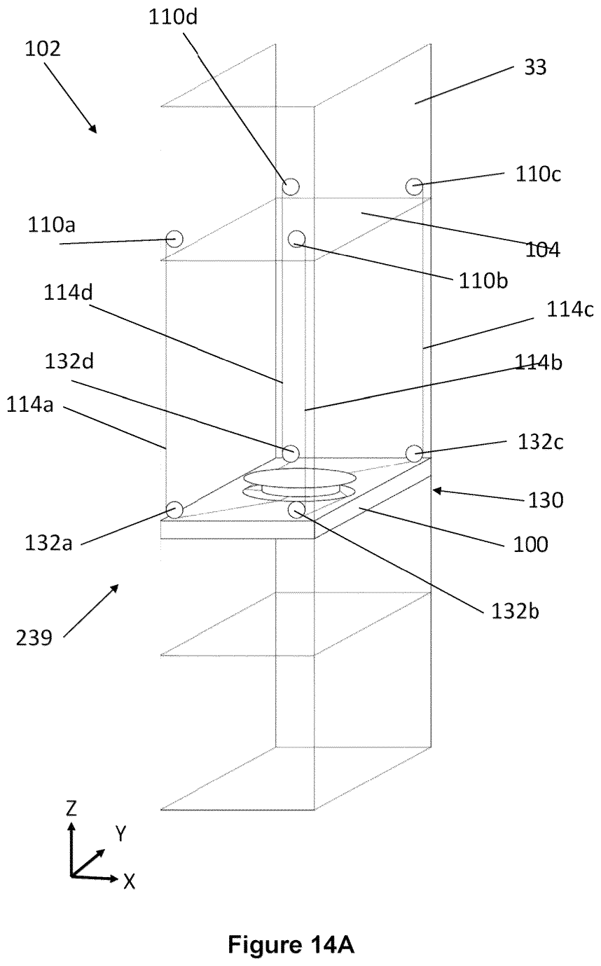

FIG. 13 shows a raising and lowering mechanism 139 of another embodiment of lifting assembly 102. In this embodiment, the raising and lowering mechanism 139 includes a central horizontally extending lifting shaft 120 and four spools, two spools 122a, 122b at the first end of the lifting shaft 120 and two spools 122c, 122d at the second end of the lifting shaft 120. The lifting assembly 102 comprises four pulleys 124a, 124b, 124c, 124d, one at each corner of the lifting assembly 102, and four tethers 114a, 114b, 114c, 114d, each tether extending from a respective spool 122a, 122b, 122c, 122d to a respective pulley 124a, 124b, 124c, 124d before extending downwards where a lower end of each tether 114a, 114b, 114c, 114d connects to the gripping device 100, e.g. a corner of the gripping device (not shown in FIG. 13). The two tethers 114a, 114b at the first end of the lifting shaft extend in opposing directions from the two spools 122a, 122b at the first end of the lifting shaft 120 and the two tethers 114c, 114d at the second end of the lifting shaft 120 extend in opposing directions from the two spools 122c, 122d at the second end of the lifting shaft such that each tether can pass through a pulley at the corner of the lifting assembly 102. In this embodiment, each of the four tethers is connected to its own spool such that a single tether is wound or unwound on each spool. This advantageously ensures that the wound tethers on each spool occupy less space compared to embodiments where two or more tethers are wound onto a single spool, for example as described in relation to the embodiment of FIG. 12. Providing a spool for each tether also advantageously reduces the risk of tangling of the tethers as they are wound and unwound to lift and lower the gripping device.

In some embodiments, the raising and lowering mechanism 139 of FIG. 13 includes slip clutches at each spool, i.e. each spool is mounted to the lifting shaft via a respective slip clutch, as described in relation to the embodiment of FIG. 12. As described above, this allows the lifting assembly 102 of the embodiment of FIG. 13 to level each corner of the gripping device 100 should it become uneven during lifting and/or lowering.

In other embodiments, the lifting assembly 102 may comprise two spools, one at each end of the lifting shaft and the spools may comprise one or more grooves to separate the two tethers on each spool.

The lifting shaft is configured to rotate so as to wind or unwind the tethers about each spool. As the lifting shaft is rotated in a first direction to wind the tethers, each tether is simultaneously wound about its respective spool so as to lift the gripping device (and a container when gripped by the gripping device). The lifting shaft is rotated in a second direction (opposite the first direction), to simultaneously unwind each tether from its respective spool, thereby lowering the gripping device (and a container when gripped by the gripping device). The tethers are wound or unwound simultaneously and at the same rate so as to lift or lower the gripping device evenly and steadily.

The lifting assembly 102 includes a motor 106 configured to rotate the lifting shaft 120 in the first and second directions so as to wind or unwind the tethers about their spools. The motor 106 is coupled to the central horizontally extending lifting shaft 120 so as to rotate the lifting shaft in the first and second directions.

The motor 106 is encased or partially surrounded by a block which protects the motor 106 and aids in holding the motor 106 in place. The four pulleys 124a, 124b, 124c, 124d are also held within blocks which are suspended or connected to the load handling device by vertical rods (not shown), thereby connecting the lifting assembly 102 to the load handling device.

The blocks are also connected by rods 128 which assemble each pulley 124a, 124b, 124c, 124d to a corner of the rectangular lifting assembly 102. Each block holding a pulley 124a, 124b, 124c, 124d includes a cutout to allow the tether 114a, 114b, 114c, 114d to extend from the spool to the pulley within the block.

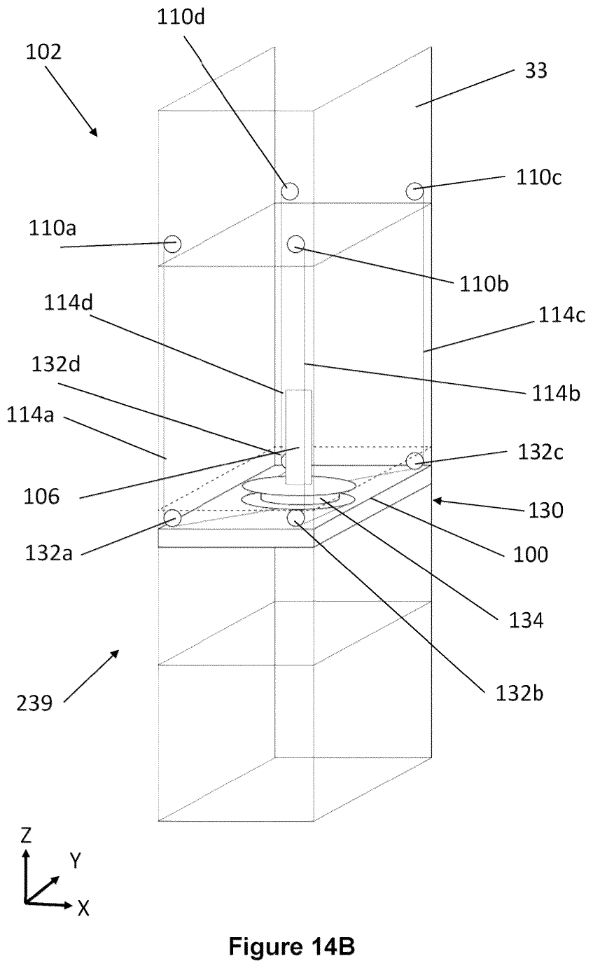

FIGS. 14A and 14B show another embodiment of lifting assembly 102. In this embodiment, the lifting assembly 102 includes a raising and lowering mechanism 239 comprising a gearing mechanism 130 provided on the gripping device. The gearing mechanism 130 winds and unwinds four tethers 114a, 114b, 114c, 114d, which connect to the gearing mechanism 130 via four pulleys 132a, 132b, 132c, 132d located at the corners of the gripping device 100. The tethers 114a, 114b, 114c, 114d extend upwards from the pulleys on the gripping device 100 to four pulleys 110a, 110b, 110c, 110d located within the body 33 of the load handling device 31. As the gearing mechanism 130 winds the tethers 114a, 114b, 114c, 114d, the gripping device 100 climbs upwards towards the load handling device 31. Due to the gearing mechanism 130 being on the gripping device 100, it can be described that the gripping device 100 ‘climbs’ as the gearing mechanism 130 winds the tethers, rather than the gripping device 100 being lifted as the tethers 114a, 114b, 114c, 114d are wound for example when the gearing mechanism is provided above the gripping device (e.g. in the load handling device body 33). In other words, the lifting power comes from the gripping device 100 rather than from a gearing mechanism provided in the body 33 of the load handling device 31. As the gearing mechanism 130 unwinds the tethers 114a, 114b, 114c, 114d, the gripping device 100 is lowered.

Providing the gearing mechanism 130 on the gripping device 100 adds weight to the gripping device 100. This advantageously helps the gripping device 100 in being lifted and lowered in a more smooth, level and steady way (e.g. compared to lighter gripping devices).

As shown in FIG. 14B, the raising and lowering mechanism 239 comprises a motor 106 which is configured to drive or rotate the gearing mechanism 130 so as to wind or unwind the tethers. The motor 106 is provided on the gripping device 100. This advantageously provides further weight on the gripping device 100, aiding the gripping device 100 in being lifted and lowered in a smooth and level way. By providing the gearing mechanism 130 and/or the motor 106 on the gripping device 100, the lifting assembly 102 achieves a redistribution of its mass which advantageously results in a more smooth, level and steady lifting and lowering of the gripping device 100.

Furthermore, by providing the motor 106 on the gripping device 100, the gripping device 100 itself is powered without the need for power cables to extend from a powered load handling device 31 to the gripping device 100. By providing the motor 106 on the gripping device 100, the gripping device 100 can act as an autonomous element that can be tasked with a mission (e.g. pick a container at a particular location in the storage structure and 11 containers deep). The gripping device 100 can use its own source of power and sensors (where provided) to carry out the task. The gripping device 100 can use its own power from the motor 106 to drive other elements on the gripping device 100 (e.g. sensors, grippers, LEDs etc).

The motor 106 and the gearing mechanism 130 are centrally located on the gripping device 100. This helps to ensure the gripping device 100 stays level as it rises and lowers. In this embodiment, the gearing mechanism 130 is a planetary gear set (e.g. an epicyclic gear set) with a vertically extending lifting shaft 134 which acts as a spindle for the tethers 114a, 114b, 114c, 114d as the gear set 130 rotates to wind or unwind the tethers.

In other embodiments, the motor 106 may be provided in the load handling device.

In some embodiments, the raising and lowering mechanism 239 may include a weight on the gripping device 100 to add weight to the gripping device instead of or in addition to providing the gearing mechanism 130 and/or the motor 106 on the gripping device 100.

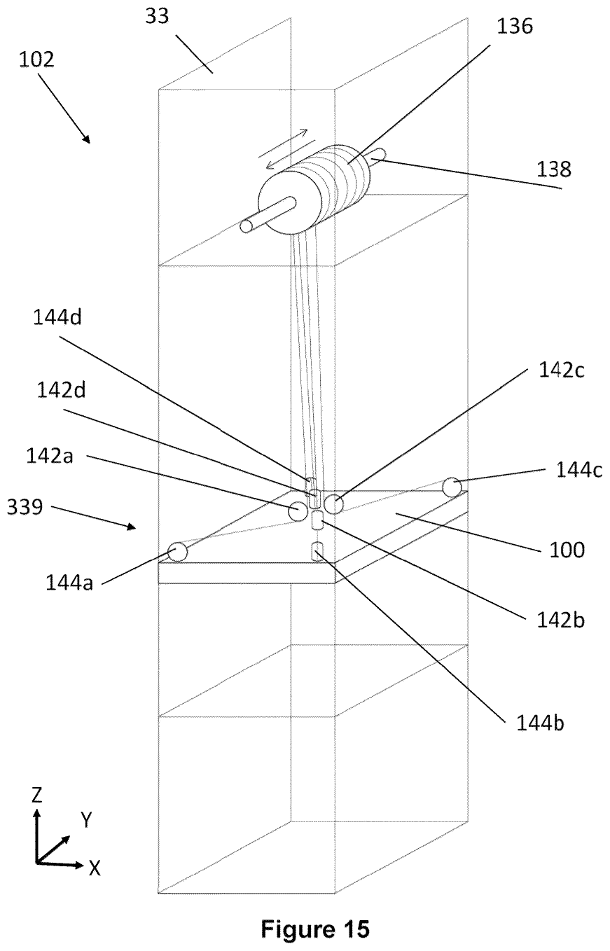

FIG. 15 shows another embodiment of lifting assembly 102. In this embodiment, the raising and lowering mechanism 339 includes a gearing mechanism in the form of a worm gear 136 mounted on a horizontally extending central shaft 138 which, in this embodiment, are located within the load handling device body 33. Although not shown, the lifting assembly 102 includes a motor 106 (e.g. in the load handling device body 33) which rotates or drives the worm gear 136 to wind or unwind four tethers 114a, 114b, 114c, 114d which spool about the worm gear 136. The worm gear 136 includes four circumferential grooves or tracks along the outside of the worm gear (i.e. the drum of the worm gear) into which the tethers wind or unwind. By providing four separate circumferential grooves, each tether can wind and unwind from the worm gear in its own groove, thereby reducing or eliminating the risk of tangling between the tethers as the worm gear rotates.

As the worm gear rotates to wind the tethers and lift the gripping device 100, the worm gear 136 travels or slides along the shaft 138 in a first axial direction (e.g. towards the right). As the worm gear rotates to unwind the tethers and lower the gripping device 100, the worm gear 136 travels or slides back along the shaft 138 in an opposite direction (i.e. opposite the first axial direction e.g. towards the left). By allowing the worm gear to travel backwards and forwards (towards the right or left) along the shaft 138 as the tethers are wound or unwound from the worm gear 136 ensures a more smooth and even winding and unwinding of the tethers from the worm gear 136. The worm gear 136 can travel along the shaft 138 due to the force of the tethers as they wind or unwind from the worm gear 136. In other embodiments, the gearing mechanism includes a spring that can bias the worm gear backwards and forwards along the shaft 138 as the tethers are wound or unwound.

In some embodiments, the drum of the worm gear 136 may be mounted to the shaft 138 via an ultra-low friction rail. This allows the turning force of the worm gear 136 alone to be sufficient to cause the tethers to wind and unwind from the worm gear and move the worm gear backwards and forwards on the shaft 138. In other words, the worm gear can ‘auto feed’ the tethers. Examples of ultra-low friction material that may be used include PTFE. The skilled person will know of a number of other suitable materials for the ultra-low friction rail.

The tethers 114a, 114b, 114c, 114d extend downwards from the worm gear 136 to four pulleys 142a, 142b, 142c, 142d on the gripping device 100, located approximately centrally on the gripping device 100 so as to keep the tethers 114a, 114b, 114c, 114d towards the centre of the lifting assembly 102. This results in a more space efficient lifting assembly 102 which requires less space within the load handling device 31. Keeping the tethers 114a, 114b, 114c, 114d towards the centre in this way also results in an easier spooling of the tethers 114a, 114b, 114c, 114d about the worm gear 136. From the centrally located pulleys 142a, 142b, 142c, 142d, the tethers extend along the gripping device to four pulleys 144a, 144b, 144c, 144d at the corners of the gripping device 100. This ensures a more stable and level lifting and lowering of the gripping device as the tethers 114a, 114b, 114c, 114d are wound and unwound by the worm gear 136.

In the embodiment of FIG. 15, a single substantially centrally located worm gear is provided to wind and unwind the tethers. In other embodiments, the lifting assembly includes a gearing mechanism in the form of two worm gears, each worm gear configured to wind and unwind two tethers. By providing two worm gears rather than one, the weight of the gearing mechanism may be more evenly distributed across the lifting assembly 102, resulting in a more balanced lifting assembly 102. Furthermore, by providing two worm gears each supporting two tethers, winding and unwinding of the tethers may be simplified and the risk of tangling of the tethers as they are wound and unwound from the worm gears may be reduced or eliminated.

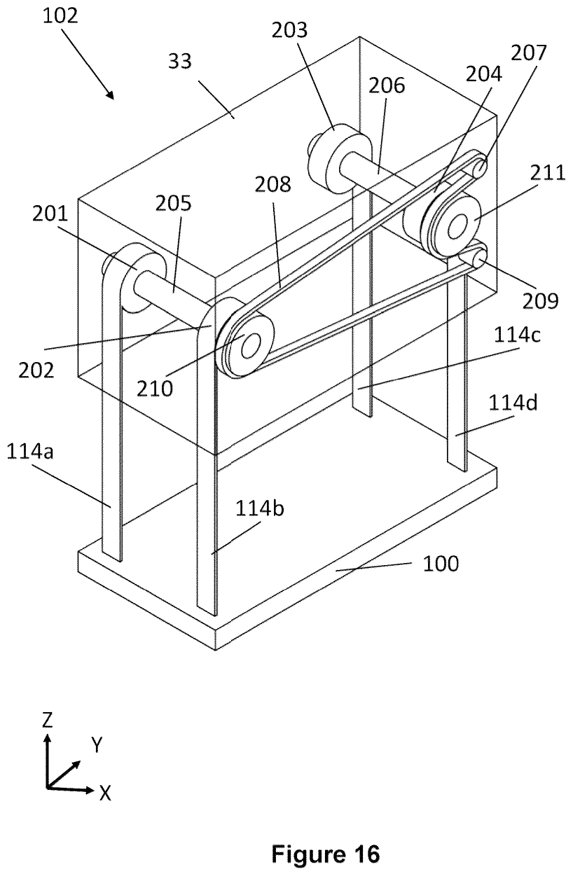

In the above embodiments, all of the cables are spooled and unspooled using a single motor 106. However, in other embodiments, more than one motor 106 may be used if desired. In the embodiment of FIG. 16, a lifting assembly 102 has four spools 201, 202, 203, and 204 to wind and unwind respective tethers. Spools 201 and 202 are on drive shaft 205, whereas spools 203 and 204 are on drive shaft 206. Drive shafts 205 and 206, when driven by a motor, are configured to rotate in opposite directions. By rotating drive shafts 205 and 206 in opposite directions, respective tethers 114a-d can be located at or near the corners of the lifting assembly, as with the embodiments above. In particular, as shown in FIG. 16, the point at which each tether winds or unwinds to or from a spool is at or near a respective corner of the lifting assembly. This allows the tethers to connect to the gripping assembly 100 at a respective corner of the gripping assembly, which increases stability when raising and lowering the gripping assembly. FIG. 16 shows one example of how drive shafts 205 and 206 can be rotated in opposite directions. Drive shafts 205 and 206 are connected to pulleys 210 and 211 respectively. A motor applies torque to pulley 207. Timing belt 208 transmits the torque to pulleys 209, 210, and 211 in a way that ensures spools 201 and 202, and spools 203 and 204 rotate in opposite directions. In particular, pulleys 207 and 209 are arranged about pulley 211 to effect its opposite rotation to pulley 210. It will be appreciated that this is only one example way in which drive shafts 205 and 206 can be made to rotate in opposite directions when driven by a motor.

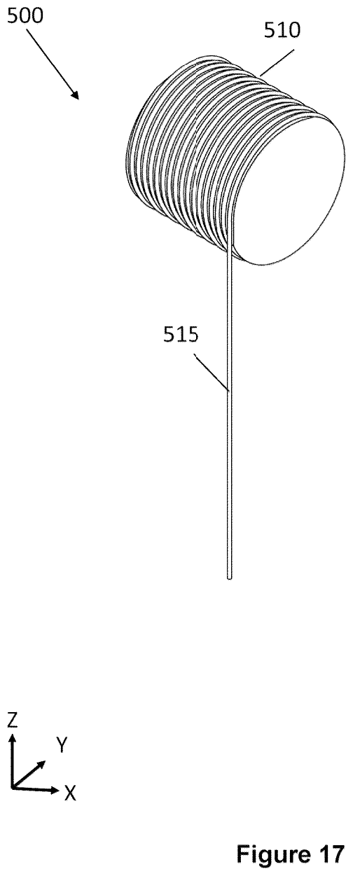

Whilst not limiting, it will be appreciated that the spools 201, 202, 203, and 204 are particularly suited to the woven polyester tapes, or woven belts (e.g. seat belts) with a conductive element or wiring woven into the belt described above. Where a wire tether is used, each spool 201, 202, 203, and 204 may be threaded to form a groove that receives/releases the wire tether as it is wound/unwound. Such a spool 500 is shown in FIG. 17, and this spool can be used with any of the embodiments described above. The depth of the groove 510, and the overall configuration of the grooves may be chosen depending on the properties of the wire 515 such as diameter and length.

Additionally, a slip clutch may be included at each spool, i.e. each spool 201, 202, 203, and 204 is mounted to the lifting shaft via a respective slip clutch, as described in relation to the embodiments of FIGS. 12 and 13. As described above, this allows the lifting assembly 102 to level each corner of the gripping device 100 should it become uneven during lifting and/or lowering.

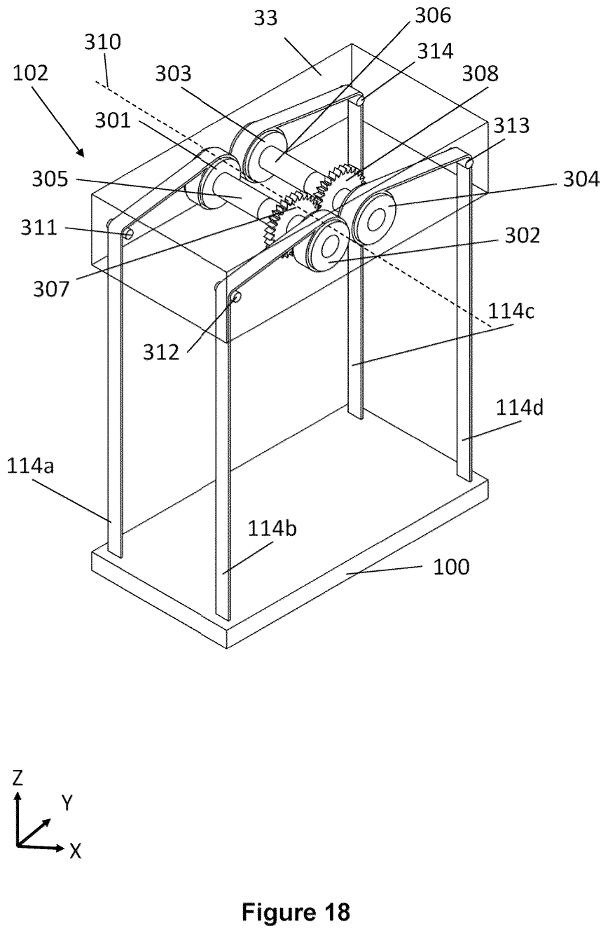

In the embodiment of FIG. 18, a lifting assembly 102 has four spools 301, 302, 303, and 304 to wind and unwind respective tethers 114a-d. Spools 301 and 302 are on drive shaft 305, whereas spools 303 and 304 are on drive shaft 306. Drive shafts 305 and 306, when driven by a motor, are configured to rotate in opposite directions. Drive shafts are operatively coupled by the meshing of gears 307 and 308. Drive shaft 305 (and thus gear 307, and spools 301 and 302) and drive shaft 306 (and thus gear 308, and spools 303 and 304) are on opposite sides of and adjacent to a central axis 310 of the lifting assembly. The central axis 310 extends in a longitudinal direction that is parallel to the longitudinal axes of drive shafts 305 and 306. The tethers from each spool extend to respective pulleys 311, 312, 313, and 314 located at or near the corners of the lifting assembly, as with the embodiments above. In particular, as shown in FIG. 18, the point at which each tether winds or unwinds to or from a pulley 311, 312, 313, and 314 is at or near a respective corner of the lifting assembly. This allows the tethers to connect to the gripping assembly 100 at a respective corner of the gripping assembly, which increases stability when raising and lowering the gripping assembly. When either drive shaft 305, 306 is driven by a motor to rotate in a first direction, the other drive shaft rotates in a second direction opposite the first direction through the meshing of gears 307 and 308. That is, gear 307 (and thus spools 301 and 302), and gear 308 (and thus spools 303 and 304) rotate in opposite directions to wind and unwind respective tethers. It will be appreciated that this is only one example way in which drive shafts 305 and 306 can be made to rotate in opposite directions when driven by a motor.

Whilst not limiting, it will be appreciated that the spools 301, 302, 303, and 304 are particularly suited to the woven polyester tapes, or woven belts (e.g. seat belts) with a conductive element or wiring woven into the belt described above. Where a wire tether is used, each spool 301, 302, 303, and 304 may be threaded to form a groove that receives/releases the wire tether as it is wound/unwound. Such a spool 500 is shown in FIG. 18, and this spool can be used with any of the embodiments described above. The depth of the groove 510, and the overall configuration of the grooves may be chosen depending on the properties of the wire 515 such as diameter and length.

Additionally, a slip clutch may be included at each spool, i.e. each spool 301, 302, 303, and 304 is mounted to the lifting shaft via a respective slip clutch, as described in relation to the embodiments of FIGS. 12 and 13. As described above, this allows the lifting assembly 102 to level each corner of the gripping device 100 should it become uneven during lifting and/or lowering.

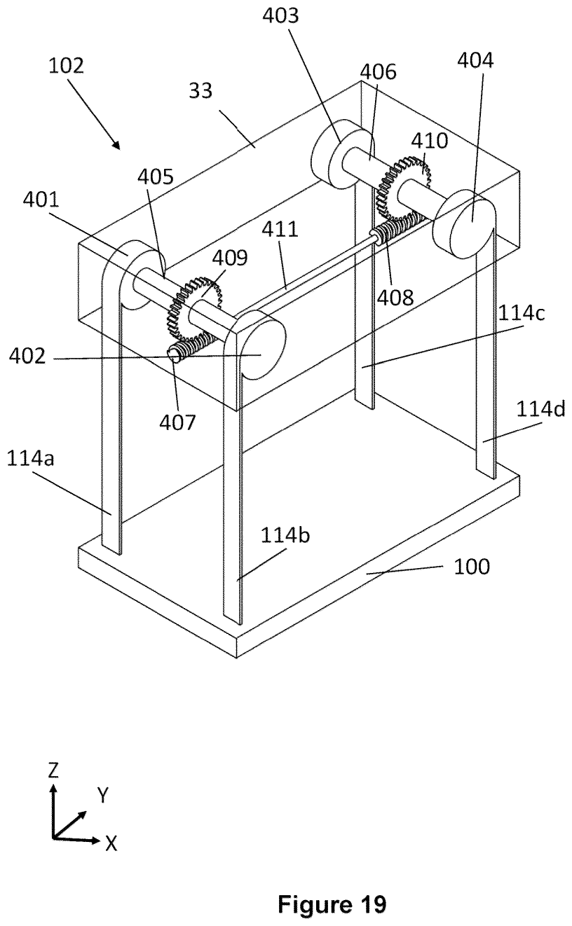

In the embodiment of FIG. 19, a lifting assembly 102 has four spools 401, 402, 403, and 404 to wind and unwind respective tethers. Spools 401 and 402 are on drive shaft 405, whereas spools 403 and 404 are on drive shaft 406. Drive shafts 405 and 406, when driven by a motor, are configured to rotate in opposite directions. By rotating drive shafts 405 and 406 in opposite directions, the tethers can be located at or near the corners of the lifting assembly, as with the embodiments above. In particular, as shown in FIG. 19, the point at which each tether winds or unwinds to or from a spool is at or near a respective corner of the lifting assembly. This allows the tethers to connect to the gripping assembly at a respective corner of the gripping assembly 100, which increasing stability when raising and lowering the gripping assembly. FIG. 19 shows one example of how drive shafts 405 and 406 can be rotated in opposite directions. A motor applies torque to a shaft 411 comprising a first worm gear 407 and a second worm gear 408. First and second worm gears 407, 408 are configured (or threaded) such that they rotate respective gears 409 and 410 in opposite directions. Gear 409 thus rotates drive shaft 405 in a first direction, and gear 410 rotates drive shaft 406 in a second direction opposite the first direction. That is, gear 409 (and thus spools 401 and 402), and gear 409 (and thus spools 403 and 404) rotate in opposite directions to wind and unwind respective tethers.

Whilst not limiting, it will be appreciated that the spools 401, 402, 403, and 404 are particularly suited to the woven polyester tapes, or woven belts (e.g. seat belts) with a conductive element or wiring woven into the belt described above. Where a wire tether is used, each spool 401, 402, 403, and 404 may be threaded to form a groove that receives/releases the wire tether as it is wound/unwound. Such a spool 500 is shown in FIG. 17, and this spool can be used with any of the embodiments described above. The depth of the groove 510, and the overall configuration of the grooves may be chosen depending on the properties of the wire 515 such as diameter and length.

Additionally, a slip clutch may be included at each spool, i.e. each spool 401, 402, 403, and 404 is mounted to the lifting shaft via a respective slip clutch, as described in relation to the embodiments of FIGS. 12 and 13. As described above, this allows the lifting assembly 102 to level each corner of the gripping device 100 should it become uneven during lifting and/or lowering. All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

1-39. (canceled)

40. A container lifting assembly for raising and/or lowering containers stacked in stacks in a grid storage structure, the lifting assembly comprising:
a gripping device configured to releasably grip a container;
a raising and lowering mechanism configured to raise and lower the gripping device, wherein the raising and lowering mechanism includes:
a first shaft, a second shaft, a first spool and a second spool on the first shaft, and a third spool and a fourth spool on the second shaft;
a first tether, a second tether, a third tether, and a fourth tether configured to wind and unwind from the first, second, third, and fourth spools respectively, wherein the first, second, third, and fourth tethers are connected to the gripping device, wherein the first and second spools are configured to rotate in an opposite direction to the third and fourth spools to wind and unwind the first, second, third, and fourth tethers to raise and lower the gripping device;
a timing belt;
a motor; and
first and second pulleys on the first and second shafts respectively, the first and second pulleys being arranged to be driven by the motor in opposite directions via the timing belt; and
wherein the first, second, third, and fourth tethers are configured such that a point at which each tether winds and unwinds to or from a respective spool is at or near a respective corner of the container lifting assembly.

41. The container lifting assembly of claim 40, comprising:
third and fourth pulleys arranged about either the first or second pulley to effect opposite rotation of the first and second pulleys via the timing belt.

42. The container lifting assembly of claim 40, wherein any one of the first, second, third, and fourth pulleys is driven directly by the motor.

43. The container lifting assembly of claim 40, wherein the first, second, third, and fourth tethers connect to the gripping device at or near a respective corner of the gripping device.

44. The container lifting assembly of claim 40, wherein at least one of the first, second, third, and fourth spools comprises:
a slip clutch.

45. The container lifting assembly of claim 40, wherein at least one of the first, second, third, and fourth spools comprises:
at least one groove configured along its circumference to receive a wire tether, and into which a wire tether is configured to wind.

46. The container lifting assembly of claim 40, wherein the at least one of the first, second, third, and fourth tethers comprises:
a conductive material or element woven into the tether.

47. The container lifting assembly of claim 46, wherein the conductive material or element is configured to provide power and/or electrical communication to the gripping device.

48. The container lifting assembly of claim 40, wherein the at least one of the first, second, third, and fourth tethers comprises:
a woven polyester tape.

49. The container lifting assembly of claim 40 in combination with a load handling device for lifting and moving containers stacked in stacks in a grid storage structure including a plurality of tracks arranged to form a grid having a grid pattern above the stacks of containers, the load handling device comprising:
a body housing a driving mechanism operatively arranged for moving the load handling device on the grid;
wherein the container lifting assembly is configured to raise and lower the gripping device relative to the body and for raising and lowering containers stacked in stacks.

50. The load handling device of claim 49, wherein the container lifting assembly is located within the body of the load handling device.

51. A method of raising and/or lowering a container from a stack of containers, in a grid storage structure including a plurality of tracks arranged to form a grid having a grid pattern above the stacks of containers, and with a load handling device which incudes:
a body housing a driving mechanism operatively arranged for moving the load handling device on the grid; and a container lifting assembly including:
a gripping device configured to releasably grip a container;
a raising and lowering mechanism configured to raise and lower the gripping device, wherein the raising and lowering mechanism includes:
a first shaft, a second shaft, a first spool and a second spool on the first shaft, and a third spool and a fourth spool on the second shaft;
a first tether, a second tether, a third tether, and a fourth tether configured to wind and unwind from the first, second, third, and fourth spools respectively, wherein the first, second, third, and fourth tethers are connected to the gripping device, wherein the first and second spools are configured to rotate in an opposite direction to the third and fourth spools to wind and unwind the first, second, third, and fourth tethers to raise and lower the gripping device;
a timing belt;
a motor; and
first and second pulleys on the first and second shafts respectively, the first and second pulleys being arranged to be driven by the motor in opposite directions via the timing belt; and
wherein the first, second, third, and fourth tethers are configured such that a point at which each tether winds and unwinds to or from a respective spool is at or near a respective corner of the container lifting assembly,
the container lifting assembly being configured to raise and lower the gripping device relative to the body and for raising and lowering containers stacked in stacks; the method comprising the steps of:
actuating the motor so as to unwind the at least one of the tethers and lower the gripping device relative to the body;
actuating the gripping device to grip a container; and
actuating the motor so as to wind at least one of the tethers and raise the gripping device relative to the body.

52. The container lifting assembly of claim 40 in combination with a load handling device and a system, the system comprising:
a storage structure for accommodating containers stacked in stacks, the storage structure including a first set of tracks extending in a first direction and a second set of tracks extending in a second direction transverse to the first direction, the load-handling device being configured to move on the first and second sets of tracks; and
a control utility configured to control the load handling device to lift a container from a stack beneath the grid and/or lower a container into the grid.
